(19) United States
(12) Patent Application Publication
(10) Pub. No.: US 2014/0023231 A1
(43) Pub. Date: Jan. 23, 2014

(54) IMAGE PROCESSING DEVICE, CONTROL METHOD, AND STORAGE MEDIUM FOR PERFORMING COLOR CONVERSION

(71) Applicant: CANON KABUSHIKI KAISHA, Tokyo (JP)

(72) Inventors: Yasuhiko Iwamoto, Tokyo (JP); Akihiko Sato, Tokyo (JP); Yoshinobu Sato, Yokohama-shi (JP); Kazuyoshi Kiyosawa, Inagi-shi (JP)

(21) Appl. No.: 13/944,170

(22) Filed: Jul. 17, 2013

(30) Foreign Application Priority Data
Jul. 19, 2012 (JP) 2012-160890

(51) Int. Cl. G06T 5/00

(52) U.S. Cl. CPC G06T 5/005
USPC 382/103; 382/165

(57) ABSTRACT

An image processing device includes: a detecting unit, which detects a specific region of a human body from image data; a color selecting unit, which selects color information relative to the detected specific region; a correction amount acquisition unit, which acquires a correction amount corresponding to the selected color information; and a color conversion unit, which performs color conversion on the specific region based on the selected color information and the acquired correction amount.

### BACKGROUND OF THE INVENTION

1. Field of the Invention

The present disclosure generally relates to image processing and, more particularly, to an image processing device for performing color conversion of an organ of a face included in an image, a control method for the same, and a storage medium.

2. Description of the Related Art

There has been known image processing which provides an effect of putting on pseudo makeup by performing color conversion on an organ of a face included in an image. Japanese Patent Application Laid-Open No. 11-120336 discloses a method and a device of simulation drawing, which expresses an image of a face, on which a makeup member such as a lipstick or color contact lenses is used, in a natural way. Specifically, in a method of drawing the image of a face, on which the makeup member is applied, using computer graphics, (1) color phase, lightness, and color saturation are obtained for a signal of each pixel in a part to be applied the makeup of an image, (2) the color phase of each pixel in the part to be applied the makeup is matched with the color phase of the makeup member, and (3) while keeping a correlation between tones, which are determined by components of the color saturation and components of the lightness, of the signals of a plurality of pixels in the image of the part to be applied the makeup, the image is converted into the tones determined by the color saturation and the lightness of the makeup member. However, with a technique disclosed in Japanese Patent Application Laid-Open No. 11-120336, the color phase of the signal of the part to be applied the makeup is matched with the color phase of the makeup member. Therefore, in view of a photographed image, the color converted region may take on an unnatural hue depending on a lighting condition or a scene during photographing.

### SUMMARY OF THE INVENTION

One of the features of the present disclosure is to provide an image processing device including: a detecting unit configured to detect a specific region of a human body from image data, a color selecting unit configured to select color information corresponding to the detected specific region, a correction amount acquisition unit configured to acquire a correction amount corresponding to the selected color information, and a color conversion unit configured to perform a color conversion on the specific region based on the selected color information and the acquired correction amount.

Further features of the present disclosure will become apparent from the following description of exemplary embodiments (with reference to the attached drawings).

### BRIEF DESCRIPTION OF THE DRAWINGS

FIG. 1 is a block diagram illustrating an exemplary configuration of a digital camera according to a first embodiment;

FIG. 2 is a view illustrating an exemplary display of a display unit in a color conversion mode;

FIG. 3A is a flowchart illustrating processing of the digital camera according to the first embodiment;

FIG. 3B is a flowchart illustrating processing of the digital camera according to a second embodiment;

FIG. 3C is a flowchart illustrating processing of the digital camera according to a third embodiment;

FIG. 4 is a flowchart illustrating details of a correction amount calculation processing according to the third embodiment; and

FIG. 5 is a view illustrating a configuration of an eye.

### DESCRIPTION OF THE EMBODIMENTS

Hereinafter, preferred embodiments of the present disclosure are described with reference to the attached drawings.

### First Embodiment

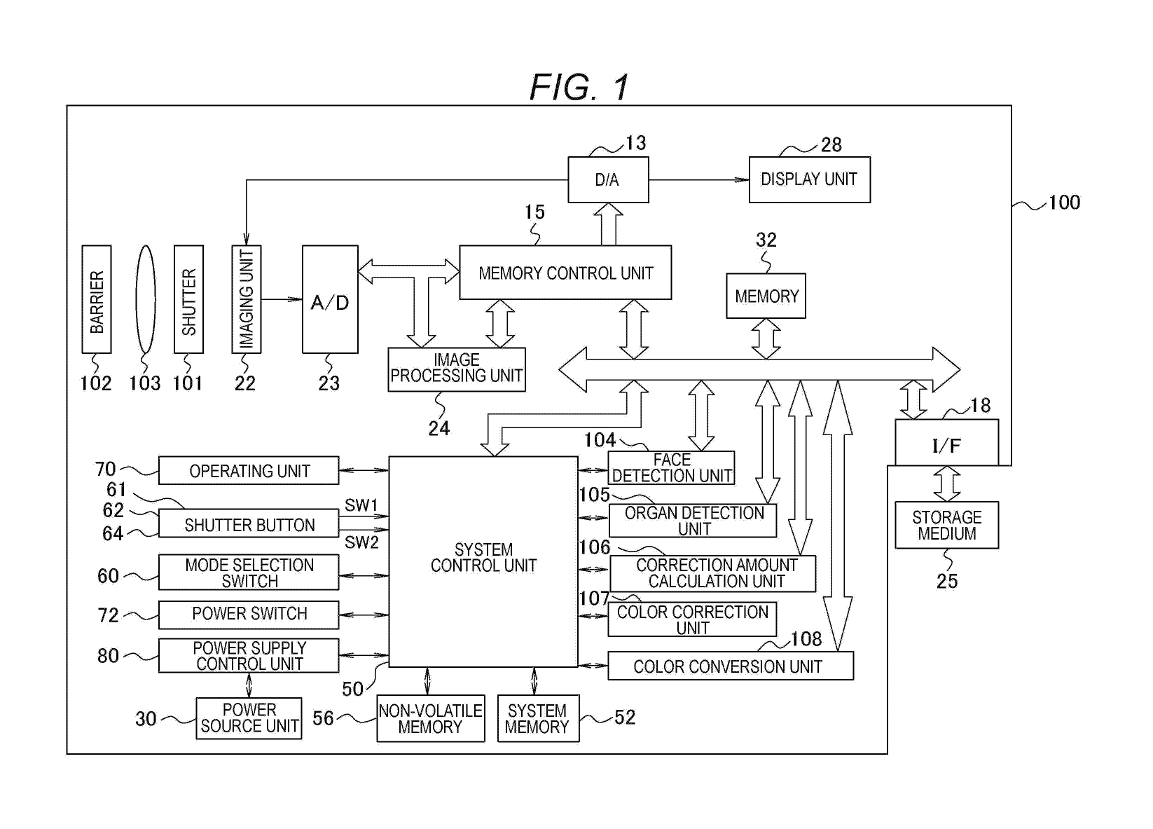

FIG. 1 is a block diagram illustrating an exemplary configuration of a digital camera 100, which functions as an imaging apparatus having an image processing device to which the present invention is applied, according to a first embodiment.

In FIG. 1, an imaging unit 22 includes a charge coupled device (CCD), a complementary metal oxide semiconductor (CMOS) element, or the like, which converts an optical image into an electrical signal. An analog to digital (A/D) converter 23 converts an analog signal output from the imaging unit 22 into a digital signal. By covering an imaging system having an imaging lens 103, which includes a focus lens, a barrier 102 of the digital camera 100 prevents a stain and a damage of the imaging system, which includes the imaging lens 103, a shutter 101 having an aperture function, and the imaging unit 22.

An image processing unit 24 performs resizing processing, such as a predetermined pixel interpolation and a reduction, and color conversion processing to data from the A/D converter 23 and data from a memory control unit 15. Furthermore, the image processing unit 24 performs predetermined arithmetic processing using captured image data, and based on a result obtained from the arithmetic processing, a system control unit 50 performs exposure control and distance measurement control. As a result, autofocus (AF) processing, automatic exposure (AE) processing, and flash pre-emission (EF) processing in the through the lens (TTL) method are performed. The image processing unit 24 further performs predetermined arithmetic processing using the captured image data, and based on a result obtained from the arithmetic processing, performs auto white balance (AWB) of the TTL method and scene determination, which determines if a scene is a sunset, a night view, an underwater view, or the like. Output data from the A/D converter 23 is directly written in a memory 32 via the image processing unit 24 and the memory control unit 15, or via the memory control unit 15. As used herein, the term “unit” generally refers to any combination of software, firmware, hardware, or other component that is used to effectuate a purpose.

The memory 32 stores image data, which is obtained by the imaging unit 22 and converted into digital data by the A/D converter 23, and image data to be displayed on a display unit 28. The memory 32 is provided with a storage capacity sufficient for storing data of a predetermined number of still images and a predetermined amount of time of moving images and sounds. Furthermore, the memory 32 also serves as a memory for image display (video memory). A digital to analog (D/A) converter 13 converts the data for image display stored in the memory 32 into an analog signal and supplies it to a display unit 28. In this way, the image data for display written in the memory 32 is displayed by the display unit 28 via the D/A converter 13. The display unit 28 performs display on the display device such as a liquid crystal display (LCD) in response to the analog signal from the D/A converter 13.

As an electrically erasable and recordable non-volatile memory 56, for example, a flash read only memory (FROM) may be used. In the non-volatile memory 56, a constant for operating the system control unit 50, a program, and the like are stored. The program here means a program for executing processing such as the ones illustrated in flowcharts described below. The system control unit 50 controls the digital camera 100 as a whole. The system control unit 50 realizes each processing described below by executing the program recorded in the non-volatile memory 56. Furthermore, the system control unit 50 also performs the display control by controlling the memory 32, the D/A converter 13, the display unit 28, and the like. As a system memory 52, for example, a random access memory (RAM) is used. In the system memory 52, a constant and a variable for operating the system control unit 50, a program read from the non-volatile memory 56, and the like are unfolded.

A mode selection switch 60 selects an operation mode of the system control unit 50 from a still image recording mode, a moving image recording mode, a reproducing mode, or the like.

A shutter button 61 is an operation unit for performing a photographing instruction, and includes a first shutter switch 62 and a second shutter switch 64. The first shutter switch 62 is turned on by a so-called half press (instruction to prepare for photographing) during operation of the shutter button 61 provided in the digital camera 100, and generates a first shutter switch signal SW1. In response to the first shutter switch signal SW1, operation of AF processing, AE processing, AWB processing, EF processing, and the like are started. The second shutter switch 64 is turned on by completion of the operation of the shutter button 61 or a so-called full press (instruction to capture image), and generates a second shutter switch signal SW2. With the second shutter switch signal SW2, the system control unit 50 starts operation of a series of photographing processing from reading of the signal from the imaging unit 22 to writing of the image data to a storage medium 25.

Each operating member of an operating unit 70 is assigned a function appropriate for each scene when various function icons displayed on the display unit 28 are selected or operated, for example, and acts as a different function button. Among the function buttons, there are an End button, a Return button, an Image Feed button, a Jump button, a Narrowing-down button, an Attribute Change button, and the like. When a Menu button is pressed, for example, a different settable menu screen is displayed on the display unit 28. Using the menu screen displayed on the display unit 28, a four-way button, and a Set button, a user can intuitively make various settings. A power switch 72 is an operating member for switching between power on and power off.

A power supply control unit 80 includes a battery detecting circuit, a direct current to direct current (DC-DC) converter, a switch circuit for switching a block to be electrified, and the like, and detects whether or not a battery is installed, a type of the battery, and a remaining battery level. Furthermore, the power supply control unit 80, based on a detection result thereof and an instruction from the system control unit 50, controls the DC-DC converter and supplies a necessary voltage to each unit including the storage medium 25 for a necessary period of time. A power source unit 30 includes a primary battery such as an alkaline battery or a lithium (Li) battery, a secondary battery such as a nickel cadmium (NiCd) battery, a nickel metal hydride (NiMH) battery, or a Li battery, an alternating current (AC) adaptor, and the like.

The storage medium 25 such as a memory card or a hard disk includes semiconductor memory, a magnetic disk, and the like, and is connected to the digital camera 100 via an interface 18.

A face detection unit 104 detects all face regions from the image data. The face region is a region constituting a face in an image. For example, a face frame, which shows a position of the face and vertical and horizontal sizes of the face, is displayed in the face region in the image. The face detection unit 104 may also be configured to detect the face region by template matching based on a face contour, for example. An organ detection unit 105 detects all organ regions within the face region detected by the face detection unit 104. The organ region is a region constituting an organ within the face region, and the organ represents an eye, a mouth (lip), a skin, a nose, and the like, which constitute the face. For example, the organ region is expressed as coordinates of a group of pixels constituting an organ. The organ detection unit 105 may also be configured to detect the organ region by the template matching based on a contour of the eye, the mouth, the nose, and the like.

The correction amount calculation unit 106, which is a correction amount acquisition unit, selects a correction amount corresponding to a result of the scene determination by the image processing unit 24 from a plurality of correction amounts stored for each scene in advance. In a case where the result of scene determination is sunset, for example, the correction amount calculation unit 106 selects the correction amount stored as the correction amount for sunset in advance, as it is. A color correction unit 107 corrects a color to a hue appropriate for the image using the correction amount acquired by the correction amount calculation unit 106. The color correction unit 107, for example, adds the correction amount to the color, and calculates a result of addition as a corrected color. A color conversion unit 108 performs color conversion on the organ region detected by the organ detection unit 105 using a color corrected by the color correction unit 107 (hereinafter, referred to as the corrected color). The color conversion unit 108, for example, scans the image of the face region and performs the color conversion by replacing color information read from a pixel corresponding to the organ region with the corrected color.

Furthermore, the digital camera 100 is capable of photographing using a center single-point AF or a face AF. The center single-point AF is to perform the AF using a single point at a central position within a photographing screen. The face AF is to perform the AF using a face detected within the photographing screen by a face detection function.

Note that a configuration of the digital camera 100 illustrated in FIG. 1 is exemplary, and it is not limited to the configuration illustrated in FIG. 1 as long as a function as the imaging apparatus and the image processing device, to which the present invention is applied, can be achieved.

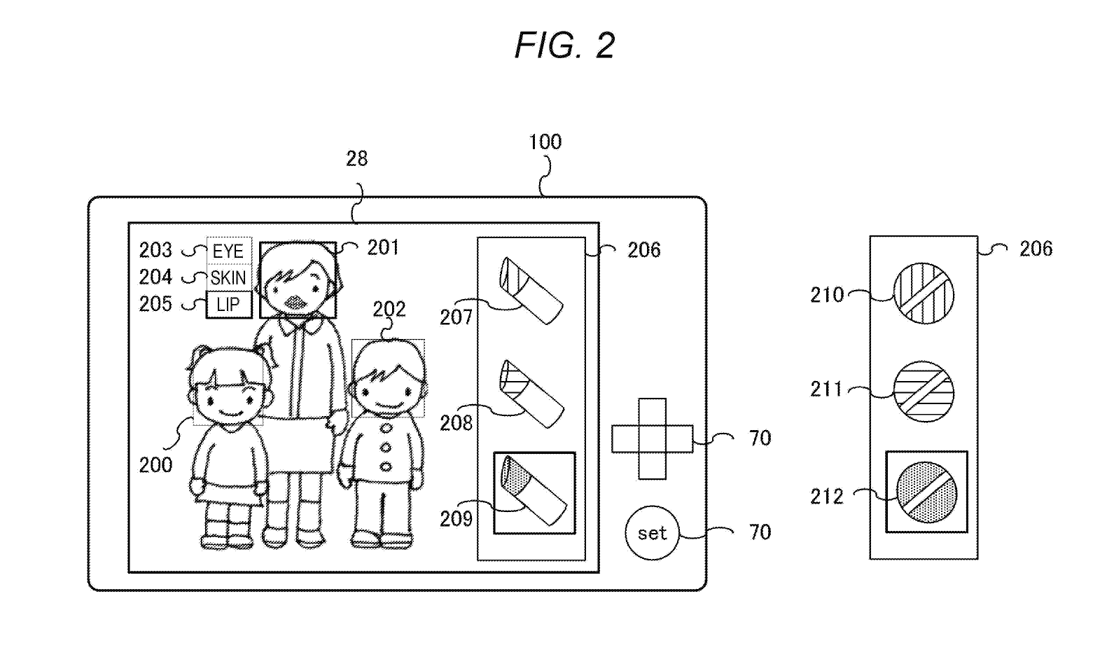

The digital camera 100 enters a color conversion mode in response to an input by the user from the operating unit 70 during the reproduction mode of an image. Hereinafter, operation performed on the operating unit 70 and an exemplary display, which is performed on the display unit 28 in response to the operation, during the color conversion mode are described with reference to FIG. 2. FIG. 2 is a view of a rear of the digital camera 100, illustrating an exemplary color conversion of a lip. The display unit 28 and the operating unit 70 are provided in the rear of the digital camera 100.

Face frames 200, 201 and 202 are displayed on the display unit 28 corresponding to the face regions detected by the face detection unit 104 within a target image. The user operates the operating unit 70 and determines a target face region by selecting one from the face frames 200, 201 and 202. In FIG. 2, the face frame 201 is selected, and the face frame 201 is displayed with a thick frame.

Organ icons 203, 204 and 205 are organs detected by the organ detection unit 105 within the target face region. The user operates the operating unit 70 and determines a target organ region by selecting one from the organ icons 203, 204 and 205. In FIG. 2, the organ icon 205, which is a lip, is selected, and a thick frame surrounding the organ icon 205 is displayed.

In a color selection menu 206, color selection icons 207, 208 and 209 are displayed. The color selection icons 207, 208 and 209 are icons representing lipsticks used in the color conversion of the target organ region. The user operates the operating unit 70 and determines a target color by selecting one from the color selection icons 207, 208 and 209. In FIG. 2, the color selection icon 209 is selected and is displayed with a thick frame.

Furthermore, in the target image displayed on the display unit 28, color conversion is performed on a color of the lip, which corresponds to the target organ region, using a corrected color.

Note that a shape of the color selection icon changes by selecting an organ icon. In FIG. 2, the target organ region is the lip, whereby the color selection icons 207, 208 and 209 are in lipstick shapes. The color selection menu 206 illustrated on the right of FIG. 2 represents the color selection menu 206 in a case where the target organ region is a skin, whereby color selection icons 210, 211 and 212 are icons representing powder puffs.

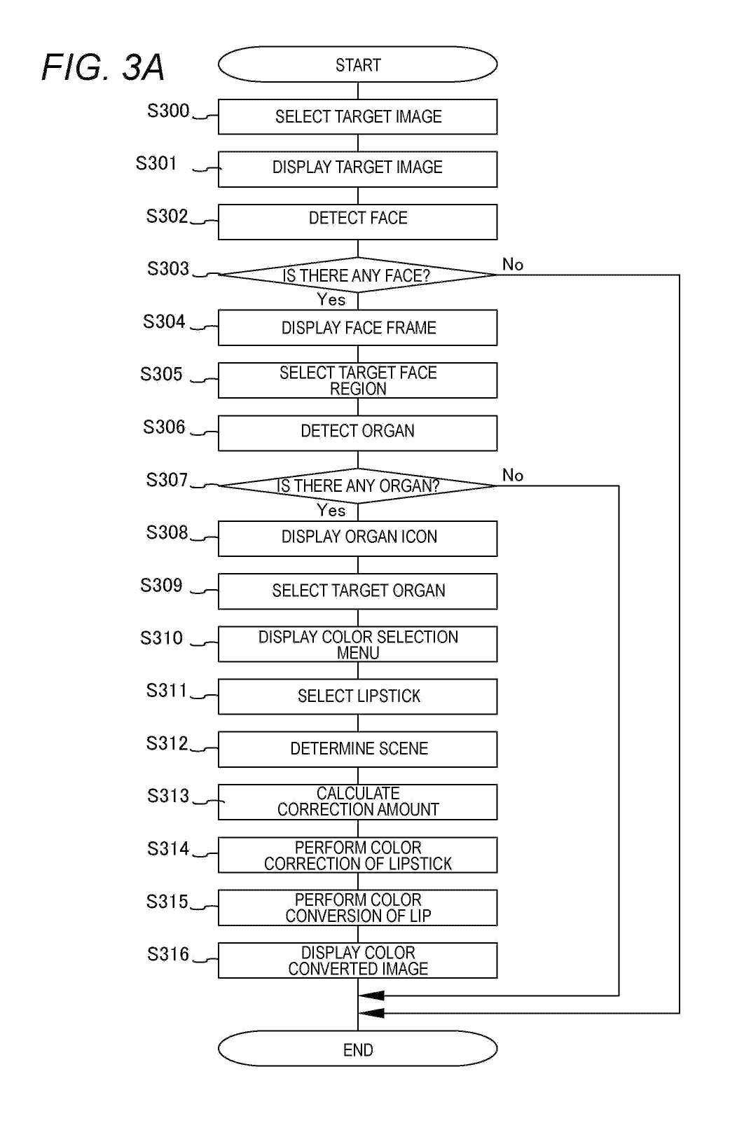

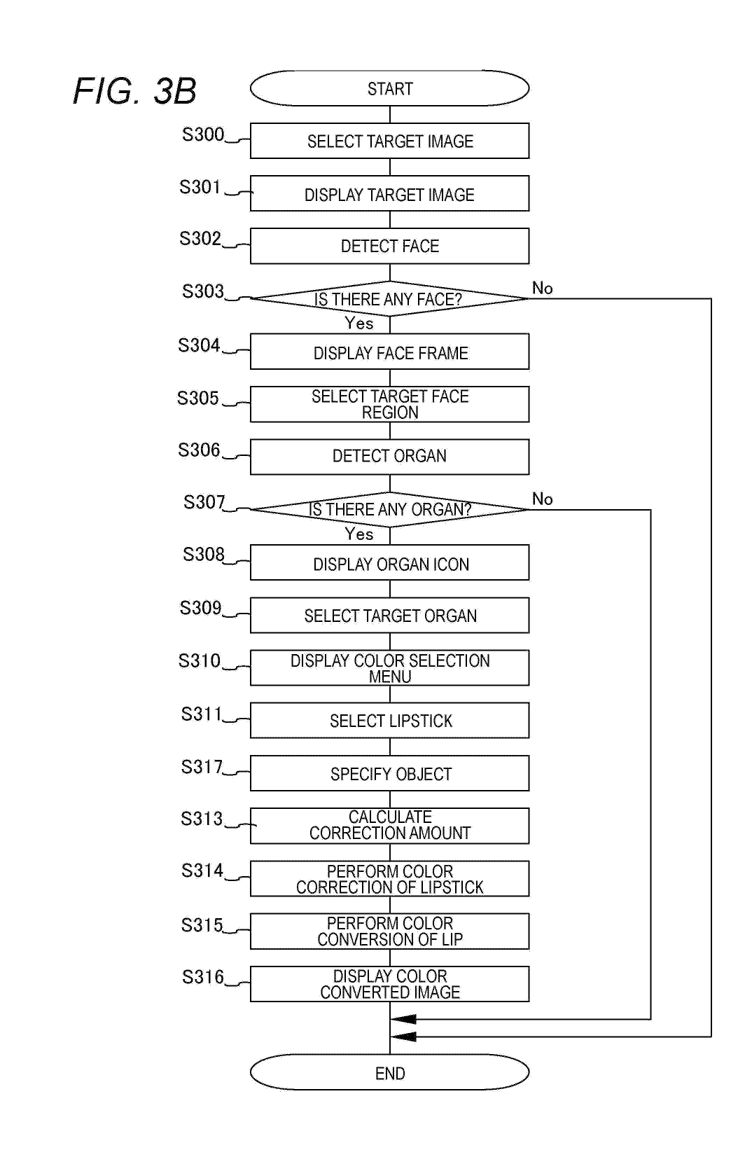

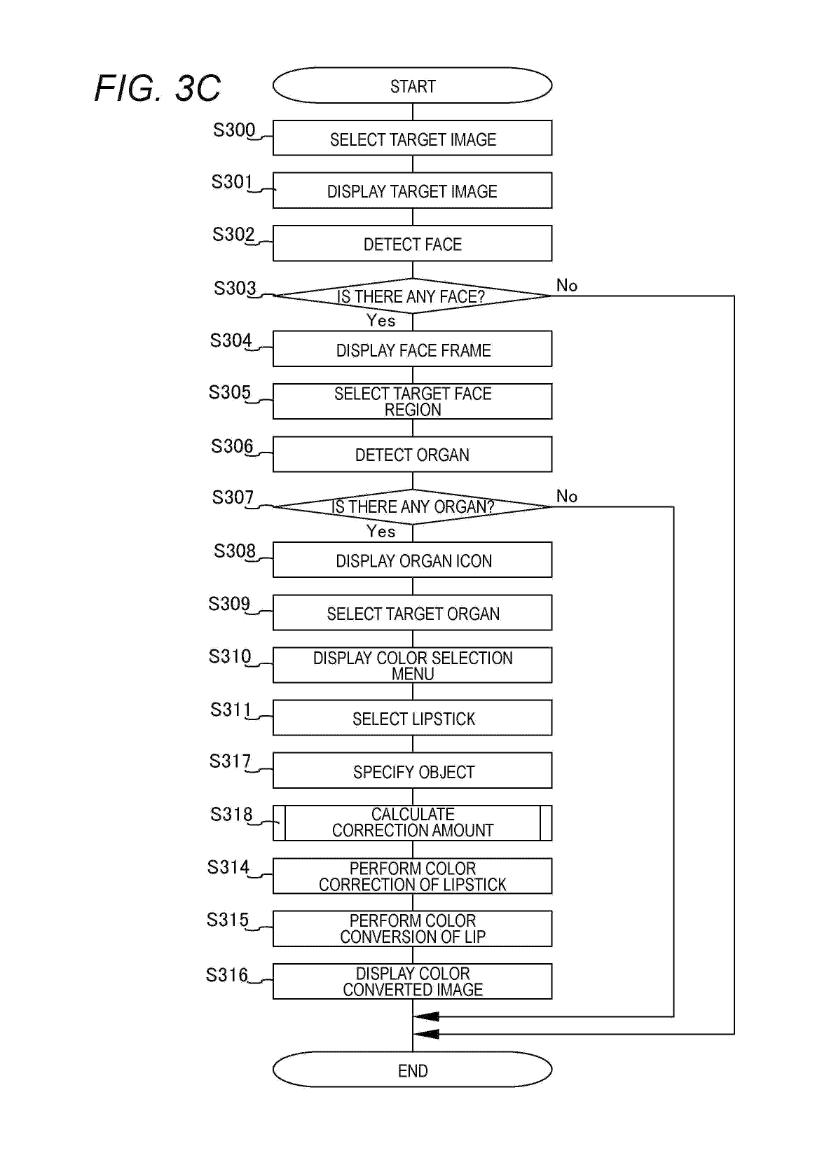

Next, a processing flow in which the operation and the display described in FIG. 2 are performed under control of the system control unit 50 is described with reference to FIG. 3A.

When the processing is started, in step S300, the system control unit 50 detects operation of the operating unit 70 by the user and selects a target image. The target image is selected from images imaged by the imaging unit 22 in advance and stored in the storage medium 25.

Next, in step S301, the system control unit 50 displays the target image on the display unit 28.

Next, in step S302, the face detection unit 104 detects the face region included in the target image.

Next, in step S303, the system control unit 50 determines whether or not the face has been detected. In a case where the face has been detected, the processing proceeds to step S304, and in a case where the face has not been detected, the processing is ended.

Next, in step S304, the system control unit 50 displays, on the display unit 28, the target image overlaid with the face frame representing the face region detected in step S302. In an example in FIG. 2, the display unit 28 displays the face frames 200, 201 and 202.

Next, in step S305, in response to the operation of the operating unit 70 by the user, the system control unit 50 selects one of the face frames as the target face region and displays the target face region with a thick frame on the display unit 28. In an example in FIG. 2, the display unit 28 displays the face frame 201 with a thick frame.

Next, in step S306, the organ detection unit 105 detects the organ region included in the target face region of the target image.

Next, in step S307, the system control unit 50 determines whether or not the organ has been detected. The system control unit 50 proceeds to step S308 in a case where the organ has been detected, and ends the processing in a case where the organ has not been detected.

Next, in step S308, the system control unit 50 displays, on the display unit 28, the target image overlaid with the organ icon representing the organ region detected in step S306. In an example in FIG. 2, the display unit 28 displays the organ icons 203, 204 and 205.

Next, in step S309, in response to the operation of the operating unit 70 by the user, the system control unit 50 selects one of the organ icons as the target organ region, and displays a thick frame surrounding the target organ region on the display unit 28. In an example in FIG. 2, the display unit 28 displays the organ icon 205 with a thick frame.

Next, in step S310, the system control unit 50 displays, on the display unit 28, the target image overlaid with the color selection menu and the color selection icon corresponding to the target organ region. In an example in FIG. 2, the display unit 28 displays the color selection menu 206 and the color selection icons 207, 208 and 209.

Next, in step S311, in response to the operation of the operating unit 70 by the user, the system control unit 50 determines the target color by selecting one of the color selection icons (the lip in this example) displayed in the color selection menu, and displays the thick frame surrounding the color selection icon on the display unit 28.

Next, in step S312, the image processing unit 24 performs the scene determination and determines if the target image corresponds to a sunset scene, a night scene, an indoor scene, or the like.

Next, in step S313, the correction amount calculation unit 106 selects the correction amount corresponding to the scene determined in step S312. The correction amount calculation unit 106, for example, in a case where it is determined that the target image is a sunset scene, selects a correction amount for increasing redness, while in a case where it is determined that the target image is a night scene, selects a correction amount for decreasing color saturation.

Next, in step S314, the color correction unit 107 calculates the corrected color by adding the correction amount to the lipstick of the target color.

Next, in step S315, the color conversion unit 108 scans the target face region in the target image, reads the color information from the pixel corresponding to the target organ region, and replaces it with the corrected color.

Next, in step S316, the system control unit 50 displays, on the display unit 28, the target image after the color conversion and ends the processing.

In the above-described first embodiment, by the correction amount calculation unit 106 selecting the correction amount according to the scene of the target image, it is possible to perform the color conversion on a color of the organ using a natural hue in accordance with the scene.

Note that it is not limited to the above-described technique as long as the correction amount, which is stored for each scene in advance, is calculated. Furthermore, the lip and the lipstick are used as an example, but it is not limited to these, and the present invention is also applicable to other organs.

### Second Embodiment

Next, a second embodiment is described. A configuration of a digital camera 100 is similar to that in the first embodiment. Therefore, mainly differences with the first embodiment are described below.

In the second embodiment, using appropriate skin color information stored for each object in advance, a correction amount calculation unit 106 calculates a correction amount to be used in color correction. More specifically, a representative skin color is calculated from color distribution in a face region of an image, and the correction amount is calculated using the representative skin color and the appropriate skin color information. For example, the representative skin color may be a value obtained through statistical processing such as a median value or an average value of color information. Furthermore, the appropriate skin color information is the color information of the skin when the object is photographed under a preferable color temperature and a setting.

Next, a processing flow in which the operation and the display described in FIG. 2 are performed under control of the system control unit 50 is described with reference to FIG. 3B.

Processing from steps S300 to S311 is as described in the first embodiment.

In step S317, an image processing unit 24 specifies an object included in a target face region. The processing here may be performed, for example, by template matching using image data corresponding to a face region and an organ region.

Next, in step S313, the correction amount calculation unit 106 calculates the representative skin color by scanning the target face region and calculates the correction amount by subtracting the appropriate skin color stored in advance for each object from the representative skin color. Processing in steps S314 to S316 is as described in the first embodiment.

In the above-described second embodiment, by the correction amount calculation unit 106 selecting the correction amount according to the skin color of the object, it is possible to perform color conversion on a color of the organ using a natural hue in accordance with the lighting condition.

Note that it is not limited to this technique of obtaining a difference as long as the correction amount is calculated using the skin color information acquired from the color distribution of the object and the appropriate skin color information.

### Third Embodiment

Next, a third embodiment is described. A configuration of a digital camera 100 is similar to that in the first embodiment. Therefore, mainly differences with the first embodiment are described below.

In a case where color information of an organ to perform a correction amount calculation is affected by a health condition of an object, presence or absence of makeup, and the like, a result of the correction amount calculation by a correction amount calculation unit 106 may be affected.

Therefore, in the third embodiment, an example using color information of an eye is described. At least a color phase value is to be obtained as the color information of the eye in this embodiment.

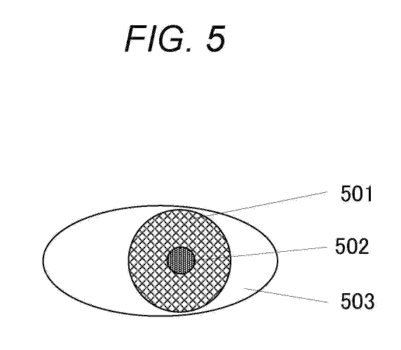

FIG. 5 is an illustration of a region related to a description of this embodiment among constituent elements of the eye. A pupil 502 provides a function to capture an outside light, and is the region where the color is mainly black. An iris 501 constitutes a circumference of the pupil 502, and is the region where the color is determined by a hereditary factor. A white of the eye 503 constitutes a circumference of the iris 501, and is the region where the color is mainly white.

It is preferable that the color information of the eye in this embodiment be the color information of the iris 501. The reason for this is based on a relationship among lightness, color saturation, and color phase which allow a color phase to be calculated accurately in intermediate lightness and high color saturation. The iris 501 is more superior than the white of the eye 503, which basically has the higher lightness, for calculating the color phase, and is more insusceptible to an adverse effect of the color information, such as a phenomenon of red eye or a golden eye, which tends to occur when a strobe light is emitted, than the pupil 502.

In the third embodiment, when the eye of the object is detected by an organ detection unit 105, the correction amount calculation unit 106 calculates a correction amount to be used in color correction using appropriate color information of an iris of the eye stored in advance for each object. For example, the appropriate color information of the iris of the eye is the color information of the iris of the eye when the object is photographed under a preferable color temperature and a setting.

Next, a processing flow in which the operation and the display described in FIG. 2 are performed under control of the system control unit 50 is described with reference to FIG. 3C.

Processing from steps S300 to S311 is as described in the first embodiment.

Processing in step S317 is as described in the second embodiment.

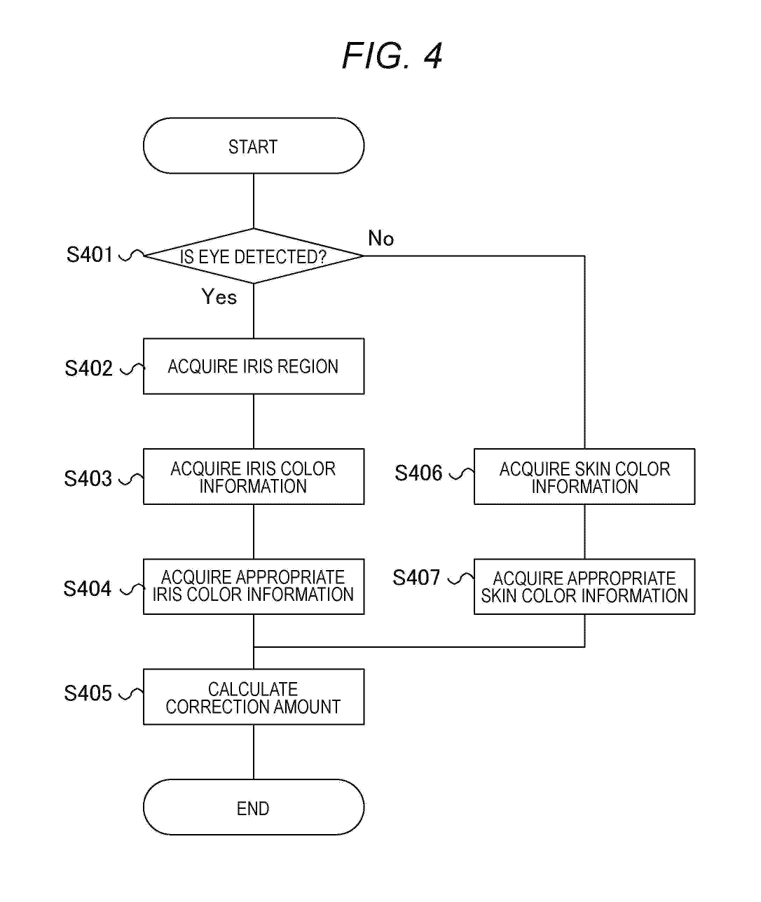

Next, in step S318, using the appropriate color information of the iris of the eye stored in advance for each object, the correction amount calculation unit 106 calculates a correction amount to be used in the color correction. Specific processing is described below using FIG. 4.

Processing from steps S314 to S316 is as described in the first embodiment.

FIG. 4 is a flowchart illustrating details of correction amount calculation processing in step S318. The processing in FIG. 4 is also performed under the control of the system control unit 50.

In step S401, the system control unit 50 determines whether or not an eye of a registered object has been detected by the organ detection unit 105. In a case where the eye of the registered object has been detected, the processing proceeds to step S402, and in a case where it has not been detected, the processing proceeds to step S406.

In step S402, the correction amount calculation unit 106 performs extraction of the iris 501 of the eye of the registered object. As an example of the extraction of the iris 501 of the eye, it is possible to acquire position information and size information of the eye from a detection result of the eye of the object, scan a pixel within a region thereof, and by detecting edges of the white of the eye 503 and the pupil 502, extract a part sandwiched by respective edges thereof as the iris 501. Next, in step S403, the correction amount calculation unit 106 acquires representative color information of the iris 501 of the eye of the registered object. The representative color information of the iris 501 of the eye may be calculated from statistical processing such as a median value or an average value of pixel data of an iris region. Then, in step S404, the correction amount calculation unit 106 acquires the appropriate color information of the iris 501 of the eye of the registered object.

On the other hand, in step S406, similar to the second embodiment, the correction amount calculation unit 106 acquires a representative skin color of the registered object. Then, in step S407, similar to the second embodiment, the correction amount calculation unit 106 acquires appropriate skin color information of the registered object.

In step S405, the correction amount calculation unit 106 calculates the correction amount by subtracting the representative color information from the appropriate color information.

In the above-described third embodiment, the correction amount calculation is performed by using the color information of the iris of the eye of a human body, a color thereof being determined by a hereditary factor. By doing so, it is possible to make the color information of the organ to be performed the correction amount calculation insusceptible to a health condition of the object, presence or absence of makeup, and the like.

Note that the above technique is an example, and it is not limited to the above-described technique as long as the correction amount is calculated using the color information of the eye in the image data and the appropriate color information of the eye stored in advance.

### Other Embodiments

Embodiments of the present disclosure can also be realized by a computer of a system or apparatus that reads out and executes computer executable instructions recorded on a storage medium (e.g., a non-transitory computer-readable storage medium) to perform the functions of one or more of the above-described embodiment(s) of the present disclosure, and by a method performed by the computer of the system or apparatus by, for example, reading out and executing the computer executable instructions from the storage medium to perform the functions of one or more of the above-described embodiment(s). The computer may comprise one or more of a central processing unit (CPU), micro processing unit (MPU), or other circuitry, and may include a network of separate computers or separate computer processors. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-160890, filed Jul. 19, 2012, which is hereby incorporated by reference herein in its entirety.

What is claimed is:

1. An image processing device comprising:
a detecting unit configured to detect a specific region of a human body from image data;
a color selecting unit configured to select color information relative to the specific region detected by the detecting unit;
a correction amount acquisition unit configured to acquire a correction amount corresponding to the color information selected by the color selecting unit; and
a color conversion unit configured to perform a color conversion on the specific region detected by the detecting unit based on the color information selected by the color selecting unit and the correction amount acquired by the correction amount acquisition unit.

2. The image processing device according to claim 1, further comprising:
a scene determination unit configured to perform scene determination of the image data, wherein
the correction amount acquisition unit acquires the correction amount corresponding to a scene determination result by the scene determination unit.

3. The image processing device according to claim 1, wherein
the detecting unit detects a skin of the human body from the image data, and
the correction amount acquisition unit calculates the correction amount using skin color information acquired from color distribution of the skin.

4. The image processing device according to claim 1, wherein
the detecting unit detects a skin of the human body from the image data, and
the correction amount acquisition unit calculates the correction amount using a difference between skin color information acquired from color distribution of the skin and corrected skin color information stored in advance.

5. The image processing device according to claim 1, wherein
the detecting unit detects an eye from the image data, and
in a case where the eye of an object is detected by the detecting unit, the correction amount acquisition unit calculates the correction amount using color information of the eye and appropriate color information of the eye stored in advance.

6. The image processing device according to claim 1, wherein
the detecting unit detects at least any one of an eye, a mouth, or a skin as the specific region.

7. An imaging apparatus comprising:
an imaging unit;
a detecting unit configured to detect a specific region of a human body from image data generated by the imaging unit;
a color selecting unit configured to select color information relative to the specific region detected by the detecting unit;
a correction amount acquisition unit configured to acquire a correction amount corresponding to the color information selected by the color selecting unit;
a color conversion unit configured to perform color conversion on the specific region detected by the detecting unit based on the color information selected by the color selecting unit and the correction amount acquired by the correction amount acquisition unit.

8. A control method for an image processing device, the method comprising:
detecting a specific region of a human body from image data;
selecting color information relative to the detected specific region;
acquiring a correction amount corresponding to the selected color information; and
performing color conversion on the detected specific region based on the selected color information and the acquired correction amount.

9. A storage medium storing a program for allowing a computer to execute a program for an image processing device, the storage medium comprising a program code for:
detecting a specific region of a human body from image data;
selecting color information relative to the detected specific region;
acquiring a correction amount corresponding to the selected color information; and
performing color conversion on the detected specific region based on the selected color information and the acquired correction amount.
